(19) United States
(12) Patent Application Publication
(10) Pub. No.: US 2009/0037271 A1
(43) Pub. Date: Feb. 5, 2009

(54) RECOMMENDING THE ADDITIONAL PURCHASE OF A LESSER INCLUDED PART OF AN ITEM, WHEN THE ITEM IS SELECTED FOR PURCHASE AND IS NOT TO BE DELIVERED VIA THE INTERNET

(76) Inventor: Anthony Jeremiah Bayne, Lomita, CA (US)

Correspondence Address: ANTHONY JEREMIAH BAYNE, 25315 ANDREO AVENUE, LOMITA, CA, 90717, US

(21) Appl. No.: 11/868,594

(22) Filed: Oct. 8, 2007

Related U.S. Application Data
(60) Provisional application No. 60/962,583, filed on Jul. 30, 2007.
(60) Provisional application No. 60/964,591, filed on Aug. 14, 2007.

(51) Int. Cl. G06Q 30/00

(52) U.S. Cl. 705/14

(57) ABSTRACT

Based on an online customer's selection of format and postal delivery option for an item (i.e. book, CD, or movie DVD) to be purchased, a computer implemented service recommends the additional purchase of a lesser included part (i.e. chapter, song, or movie scene) of the same item, in a digital format for download or access. The online customer who follows the recommendation will be able to download any selected lesser included part(s), or access any selected lesser included part(s) at a website controlled by the online merchant. In this way the online customer will have a “get it now option”, so that the customer may begin enjoying a lesser included part of the item immediately while waiting for the item to be delivered by postal carrier.

### RELATED APPLICATIONS

This application claims the benefit of priority to U.S. Provisional Applications Ser. No. 60/962,583 filed Jul. 30, 2007 and Ser. No. 60/964,591 filed Aug. 14, 2007. Each of the foregoing applications is hereby incorporated by reference in its entirety.

### BACKGROUND OF THE INVENTION

1. Field of the Invention

The present invention relates to an online recommendation system, and more particularly to recommending a purchase of, or paid viewing of, a lesser included part of an item currently selected by a customer for purchase, when said item is not to be delivered via the internet.

2. Description of the Related Technology

People purchase items (e.g. books, music CDs and DVD movies) from on-line merchants (e.g. Amazon.com). These merchants offer various postal delivery options to their customers. As used herein, “postal” refers to a delivery made by a person (e.g. a United States Postal Service mail carrier) to a street address or P.O. Box. “Delivery options” means the speed of a delivery (e.g. standard delivery). However, even when an online customer selects A next-day delivery option, he must wait at least until the next-day to receive the item selected.

Some books may also be purchased in a digital format, a so called “e-book” that may be delivered via the internet and downloaded. As used herein, “digital format” means an item that is capable of being delivered, or accessed via the internet. E-books may be delivered over the internet immediately after purchase and often cost less than a soft cover or hard cover book. However, for the bibliophile, an e-book may not satisfy the “book experience” of the heft of the book, cracking opening a new book, the smell of a book, etc.

Likewise, while downloading movies and music via the internet are popular, some people enjoy having an artist's music CD, or movie DVD in its physical encased form (e.g. for a gift, collect cover art, etc.).

Prior art teaches recommendation systems that make recommendations of other items to an online customer that may be similar to the item currently (or previously) selected by the online customer. The recommendations are made while the customer browses or during checkout, and are based on factors including the subject matter or author of said item(s).

### BRIEF SUMMARY OF THE INVENTION

The invention includes a system and method for recommending a lesser included part (i.e. individual chapters, song titles or scenes) of the same item currently selected by an online customer for purchase. The recommendation is based on factors extrinsic to the internal characteristics (e.g. subject matter) of the item selected. For an additional fee, a part of the selected item may be downloaded by the online customer, or may be made available to read/view only, on a website controlled by the online merchant.

When the customer selects an item for purchase in a non-digital format, the invention recommends the additional purchase of a chapter(s), song(s), or scene(s) in a digital format of the same book, CD, or DVD movie currently selected, when available, so that the customer may start enjoying the purchase immediately.

Online book sellers often sell titles at a price less than a traditional brick and mortar retailer, and so while the customer may have to pay for shipping, the perceived savings in time, cost of gas, etc., outweighs this expense. Thus, a customer may be inclined to follow a recommendation to additionally purchase instant access to a chapter of the book, song of the CD, or a movie scene of the DVD selected for purchase, and still be at a psychological “break even” point. By giving the customer a “get it now” option, the invention provides a way for the customer to “Have his cake and eat it too”.

In a preferred embodiment, the system determines if the customer selects an item for purchase in a non-digital format and an expedited postal delivery option of that item, before suggesting the additional purchase of a lesser included part of that item in a digital format during checkout. The system interprets an expedited postal delivery selection as indicia that the customer may be willing to spend more for instant (if not partial) gratification.

In an alternate embodiment, a recommendation may be made for any item selected (i.e. book, CD, DVD) that is not in a digital format, notwithstanding the postal delivery option selected, when at least one chapter, song, or movie scene of the item selected is available in a digital format.

In yet another alternate embodiment, the system determines if the customer selects a “new” book when comparable “used” books are available, before making a recommendation. In this embodiment the system interprets the selection of a “new” over a “used” item, as indicia that cost savings is not a concern of the customer, and so may be willing to spend more for instant gratification.

In yet another embodiment, the system determines if the purchase price exceeds a “price trigger” before making a recommendation. In this embodiment, the system interprets the purchase price exceeding a price trigger as indicia that the customer may have the means, and so may be willing to purchase an additional part of one or more of the selected items. For example, the system may require that the purchase price of at least individual item be exceeded (e.g. more than $500 for one item), or the total sales price of two or more items be exceeded (e.g. the total for two or more items exceeds $1,000), or the average purchase price of two or more items is exceeded (e.g. the average purchase price exceeds $500 per item) before making a recommendation.

In yet another embodiment, no recommendation to buy a lesser included part of an item for download will be made, but rather the recommendation will be to purchase access (read only/view only) a part of an item, so that no delivery of a selected part of an item will be made to the customer. Instead the online customer will be provided an access code to read (only) at least a chapter of the book, or view (only) at least a scene of a movie, at a website controlled by the online merchant. The access code may be provided to the customer in a field on his receipt, or separately emailed with a link to the customer that he can follow to a website controlled by the online merchant to view/read the selected part.

### BRIEF DESCRIPTION OF THE DRAWINGS

FIG. 1 illustrates a website that implements a recommendation service which operates in accordance with a preferred embodiment of the invention, and illustrates the flow of information between components.

FIGS. 2A & 2B illustrates a sequence of steps that are performed by the recommendation process to generate a recommendation.

### DETAILED DESCRIPTION OF THE DRAWINGS

The various features and methods of the invention will now be described in the context of a recommendation service, and a specific implementation thereof, that is used to recommend lesser included chapter(s), movie scene(s), song title(s), and music title(s) of the same book, DVD and CD currently selected for purchase by an online customer. A “shopping cart” is a data structure and associated code which keeps track of items that have been selected by a user for purchase. Purchasing an item on-line, search engines, associated databases, ordering process modules for accepting and processing modules, as well as online shopping cart processes are well known to those skilled in the art, and so are not described in further detail herein.

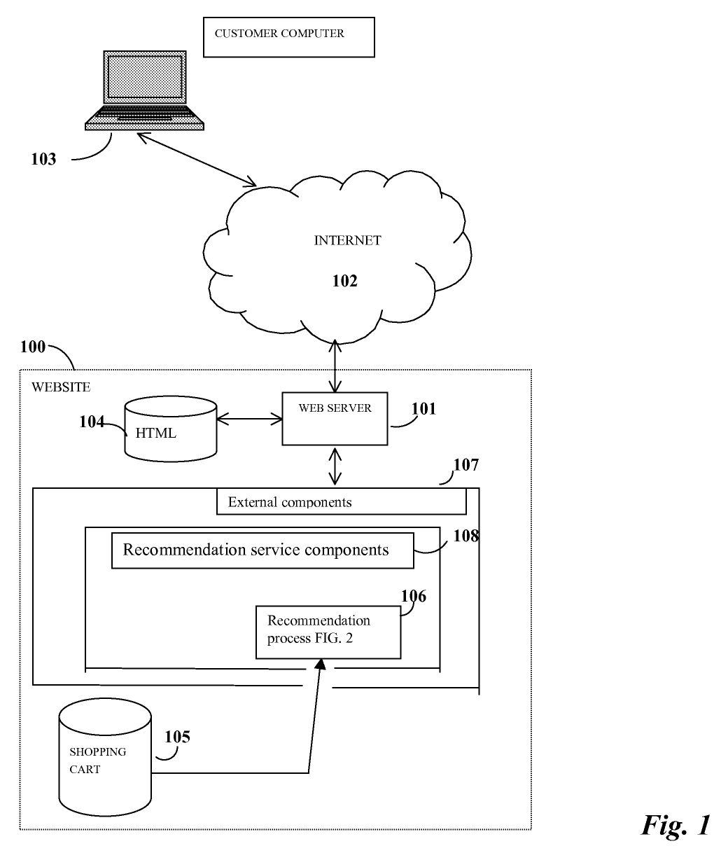

FIG. 1 shows the basic components of an on-line website 100 and the components that implement the recommendation service. The arrows in FIG. 1 show the general flow of information that is used by the recommendation service. As illustrated by FIG. 1, the website 100 includes a web server application 101 (“web server”) which processes HTTP (Hypertext Transfer Protocol) requests received over the internet 102 from at least one customer computer 103. The web server 101 accesses a database of HTML 104 (hypertext markup language) content which includes product information pages and other browsable information about various products of the catalog. The items that are subject of the recommendation service are the individual chapters, scenes and songs of books, DVD movies and CDs respectively, that are represented as titles in the shopping cart 105.

The website 100 also includes a shopping cart database 105 whose current contents are used by the recommendation service as input data to generate recommendation(s) to the customer.

As shown in FIG. 1, the web server 101 communicates with various external components 107 of the site. These external components 107 include, for example, a search engine and associated database (not shown) for enabling users to interactively search the catalog for particular items. The external components 107 also contain various order processing modules (not shown) for accepting and processing orders. The external components 107 also include a shopping cart process (not shown) which adds and removes items from the users' personal shopping cart based on the actions of the respective users. “Process” is used herein to refer generally to one or more code modules that are executed by a computer system to perform a particular task or set of related tasks.

The external components 107 also include recommendation service components 108 that are used to implement the site's recommendation service. Recommendations generated by the recommendation service are returned to the Web server 101. The recommendation service components 108 also include a recommendation process 106 that collectively implements the Recommendation Service. As depicted by the arrows in FIG. 1, the recommendation process 106 generates recommendations based on the currently selected items placed by the customer in the shopping cart 105 for purchase. In a preferred embodiment, the recommendation process 106 generates recommendations based on the currently selected items placed by the customer in the shopping cart 105 and the postal delivery option selected for those items.

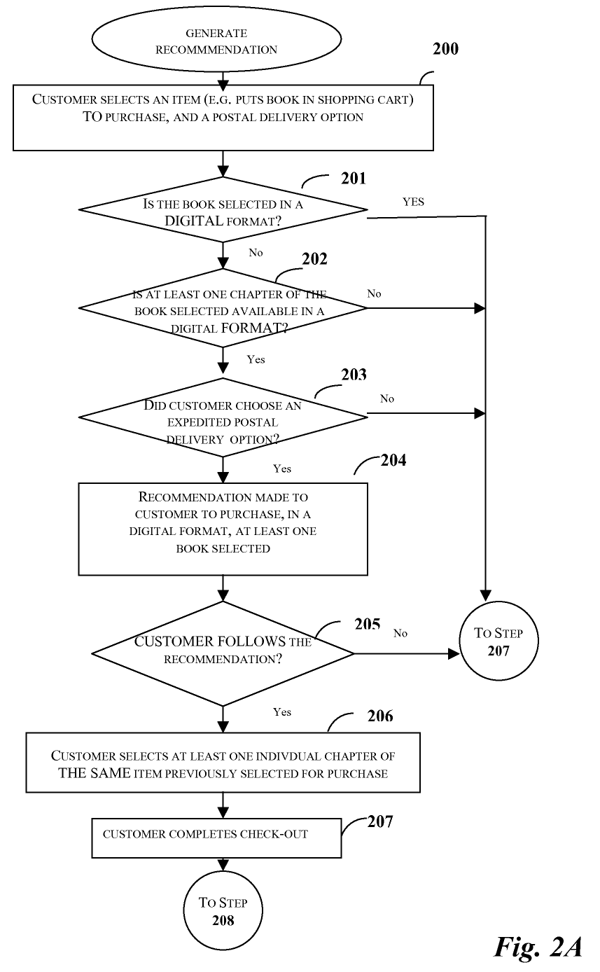

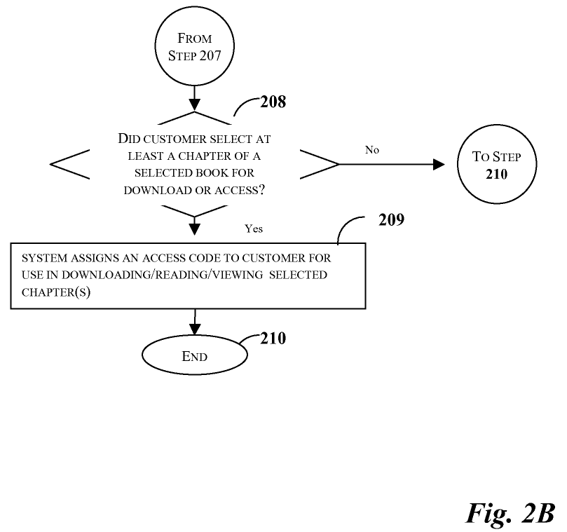

FIGS. 2A & 2B illustrates a preferred embodiment of sequence of steps that are performed by the recommendations process 106 to generate a recommendation to the customer. This process is intended to illustrate, and not limit, the scope of the invention. The FIG. 2 recommendation process 106 is preferably invoked in real time in response to an online action of the customer. In a preferred embodiment, the recommendations are generated based on the customer's current shopping cart contents and postal delivery option selected. In alternate embodiments, in addition to, or instead of the postal delivery option selected, recommendations may be based on other factors, including: the customer selecting a “new” book when “used” books of equal quality are available for purchase, the price of a selected item, the total price of two or more selected items, or the average price of two or more selected items exceeding a dollar trigger amount. Accordingly, a recommendation to the customer that he purchase a lesser included part of an item in a digital format, or pay to access a part of an item already in the customer's shopping cart 105 selected for purchase, is preceded by the determining one or more indicia that a customer may be receptive to receiving such a recommendation.

The first step 200 of the recommendation generation method is identifying what item is placed in the shopping cart 105 by the customer. An “item” includes a book, music CD, or DVD movie. However, for purposes of illustration, the method will be described in the context of a book purchase. Once the customer selects at least one book for purchase, the method proceeds to step 201 where it is determined if the online customer selected a book in a digital format. If the customer purchases the book in a digital format, the method proceeds to step 207 where the customer checks out

When the book selected for purchase is not in a digital format, the method proceeds to step 202, where it is determined if at least one chapter of the book is available in a digital format. If at least one chapter is not, the method proceeds to step 207 where the customer checks out.

If at least one chapter of the book is available in a digital format, the method proceeds to step 203 where, in a preferred embodiment, it is determined if the customer chose an expedited postal delivery option (e.g. overnight delivery). If the customer does not choose an expedited postal delivery option, the method proceeds to step 207 where the customer completes check out.

In an alternate embodiment, instead of, or in addition to step 203, the method may use a “price trigger” before making a recommendation. The price trigger may be the purchase price of a single item, the total price of two or more items, or the average purchase price of two or more items selected. In yet another embodiment, a recommendation trigger may be the customer selecting a “new” book when a “used” book in similar condition is available. In yet another embodiment, the method may omit step 203, and go directly from step 202 to step 204 when the online merchant is solely interested in making the most number of recommendations possible.

If it is determined that the customer selected an expedited postal delivery option, the method proceeds to step 204 where the method recommends that the customer purchase at least one chapter in a digital format of each book in his shopping cart that is not being purchased in a digital format.

In an alternate embodiment, the method recommends that the customer purchase access to (“read only”) at least one chapter(s) in a digital format of each book selected that is not in a digital format. In this embodiment the customer will not be sent at least one chapter for download, but rather the online customer will be supplied an access code to subsequently access a website to read the at least one chapter, or read the book online for a set amount of time (e.g. when the customer selects next day delivery, the method allows the customer 24 hours of read only online access to the item). The access code will be provided in a field on the customer's receipt at check-out, or will be separately sent to him, with a link, via e-mail.

The method then proceeds to step 205 where a determination is made whether the customer follows the recommendation. If the customer does not follow the recommendation, the method proceeds to step 207 where the customer completes check out. If the customer follows the recommendation, the method proceeds to step 206 where the customer selects at least one chapter of a book to place in his shopping cart 105 for additional purchase, or viewing access.

After selecting at least one additional chapter for purchase or viewing access, the method proceeds to step 207 where the customer checks out (e.g. confirms the selection of items for purchase/viewing, payment method, delivery address, delivery option, etc.). The method proceeds to step 208 where it is determined if the customer purchased at least one chapter for download, or read only access.

If the customer did not purchase at least one chapter for download or read-only access of the book selected, the method proceeds to step 210 where a receipt is presented on screen to the online customer to save or printout, and ends. Otherwise, the method proceeds to step 209 where an access code is assigned to the customer and inserted in a field of his receipt, so he may download or access the purchased part(s). The method then proceeds to step 210 where the receipt and access code are presented on screen to the online customer to save or printout, and ends.

In an alternate embodiment, a link and access code may be separately emailed to the customer for the customer to download/access selected chapter(s) at a website controlled by the online merchant.

I claim:

1. A method of recommending a part of an item in a digital format to an online customer, comprising:
identifying an item selected by an online customer for purchase,
determining if the item selected is in a digital format,
determining if a part of the item selected is available in a digital format, when the item selected is not in a digital format; and
recommending to the online customer an additional purchase of the part of the item that is available in a digital format, when the item selected is not in a digital format, and a part of the item is available in a digital format.

2. The method of claim 1, wherein the item selected comprises a group comprised of a book, a CD and a DVD.

3. The method of claim 1, wherein an item is in a digital format when the item is capable of being delivered via the internet.

4. The method of claim 1, wherein the part of the item selected comprises a group comprised of a chapter, a song, a music video, and a movie scene.

5. The method of claim 1, further comprising the steps of:
determining if the online customer follows the recommendation; and
delivering via the internet all selected parts to the online customer for download, when the online customer follows the recommendation.

6. The method of claim 1, further comprising the steps of:
determining if the customer selects an expedited postal delivery option for the item selected; and
making the recommendation, when the customer selects an expedited postal delivery option.

7. The method of claim 1, further comprising the steps of:
determining if a price trigger is exceeded; and
making the recommendation when the price trigger is exceeded.

8. The method of claim 7, wherein the price trigger is comprised of a group of price triggers, consisting of the price of a single item selected, the total price of two or more items selected, and the average price of two or more items selected.

9. A computer-readable medium having stored thereon computer-executable instructions for performing the method of claim 1.

10. A computer implemented method of recommending a part of an item in a digital format to an online customer, comprising:
identifying an item selected by an online customer for purchase,
determining if the item selected is to be delivered via the internet;
determining if a part of the item is available for delivery via the internet, when the item is not to be delivered via the internet; and
recommending to the online customer that the online customer pay to access a part of the item selected on a website, when the item selected is not to be delivered via the internet, and a part of the item is available for delivery via the internet.

11. The method of claim 10, wherein the item selected is a book or a movie DVD.

12. The method of claim 10, wherein the part of the item comprises a group consisting of at least one chapter of a book, and at least one movie scene.

13. The method of claim 10, wherein website access is made available to the online customer when the online customer follows the recommendation.

14. The method of claim 10, wherein the website is controlled by an online merchant.

15. The method of claim 10, wherein the website is accessed by inputting an access code provided to the online customer by the online merchant.

16. The method of claim 10, wherein the access is read only and view only access.

17. A system for providing a recommendation to an online customer, comprising:
means for identifying an item selected by an online customer for purchase;
means for identifying whether the item is to be delivered via the internet; and
means for making a recommendation to the online customer to purchase a lesser included part of the item selected, when the item selected is not to be delivered via the internet.

18. The system of claim 17 where the lesser included part of the item selected comprises a group, comprised of a chapter of a book, a movie scene, a song title, and a music title.

19. The system of claim 17, further comprising the steps of:
means for determining if an expedited postal delivery option was selected for the item; and
means for making the recommendation when the expedited postal delivery option was selected.

20. The system of claim 17, further comprising the steps of:
means for determining if a price trigger is exceeded, where the price trigger is a group comprising the purchase price of a single item selected, the total purchase price of two or more items selected, and the average purchase price of more than one item selected; and
means for making the recommendation to purchase a lesser included part of at least one item not to delivered via the internet, when the price trigger is exceeded.
